(19) United States
(12) Patent Application Publication
(10) Pub. No.: US 2006/0061449 A1
(43) Pub. Date: Mar. 23, 2006

(54) Laminated varistor, mounting structure of laminated varistor, and varistor module

(76) Inventor: Satoshi Kazama, Gunma (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/227,775

(22) Filed: Sep. 14, 2005

(30) Foreign Application Priority Data
Sep. 15, 2004 (JP) 2004-268322

(51) Int. Cl. H01C 7/10

(52) U.S. Cl. 338/21

(57) ABSTRACT

A laminated varistor having excellent radiation capability is provided. A heat conductor portion is disposed on the top surface of a rectangular parallelepiped laminated chip including a plurality of first conductor layers and a plurality of second conductor layers disposed alternately in a lateral direction with varistor layers therebetween, and the heat conductor portion is connected to a top end of each second conductor layer. Therefore, when the heat from an exothermic device, e.g., an IC, disposed in the vicinity is transferred to each of the first conductor layers and the second conductor layers via a first electrode portion and a second electrode portion or when heat generation occurs as a current passes through the varistor layers, the heat is directly and highly efficiently transferred from each second conductor layer to the heat conductor portion, and is effectively released to the outside from the heat conductor portion.

### BACKGROUND OF THE INVENTION

1. Field of the Invention

The present invention relates to a laminated varistor provided with a plurality of conductor layers (internal electrodes) in a laminated chip, a mounting structure of laminated varistor constructed by mounting the laminated varistor on a substrate, and a varistor module constructed by disposing a plurality of laminated varistors on a conductor sheet.

2. Description of the Related Art

In the laminated varistor, a plurality of internal electrodes are disposed oppositely with varistor layers therebetween in a rectangular parallelepiped chip (refer to Japanese Unexamined Patent Application Publication No. 2003-68508). The plurality of internal electrodes have a rectangular planar shape, and ends of individual internal electrodes in a length direction are alternately led to one surface and the other surface of the chip in a length direction. The ends of a part of internal electrodes led to the one surface are connected to one external electrode, and the ends of remaining internal electrodes led to the other surface are connected to the other external electrode. This laminated varistor has the function of protecting circuits and circuit constituent elements from irregular voltages, e.g., static electricity.

The laminated varistor is disposed in the vicinity of exothermic devices, e.g., ICs, from the viewpoint of the function thereof. Therefore, the heat from the exothermic device tends to be transferred to the laminated varistor. Put another way, when the laminated varistor has a heat radiation function, a component specifically for radiation becomes unnecessary.

If there are variations in particle diameters of the varistor layer, a current passes locally through a portion including smaller number of grain boundaries so as to generate heat, the varistor layer is locally broken due to the heat generation, and the original capability is deteriorated. That is, even when the heat generation occurs, the deterioration of the original capability can be prevented if the heat can be radiated effectively.

### SUMMARY OF THE INVENTION

The present invention was made in consideration of the above-described circumstances. Accordingly, it is an object of the present invention to provide a laminated varistor having excellent radiation capability, a mounting structure of being a laminated varistor, and a varistor module.

In order to achieve the above-described object, a laminated varistor according to an aspect of the present invention is provided with a rectangular parallelepiped laminated chip including a plurality of first conductor layers and a plurality of second conductor layers disposed alternately and oppositely with varistor layers therebetween, at least one first electrode portion disposed on one surface of the laminated chip and connected to the first conductor layers, at least one second electrode portion disposed on the one surface of the laminated chip and connected to the second conductor layers while the second electrode portion is in no contact with the first electrode portion, and at least one heat conductor portion disposed on at least one of the surfaces different from the one surface of the laminated chip and connected to at least the first conductor layers or the second conductor layers.

In a mounting structure of laminated varistor according to an another aspect of the present invention, at least one laminated varistor is mounted on a substrate in such a way that a first electrode portion of the laminated varistor is connected to a first land on a mounting surface and a second electrode portion is connected to a second land on the mounting surface, wherein the laminated varistor is provided with a rectangular parallelepiped laminated chip including a plurality of first conductor layers and a plurality of second conductor layers disposed alternately and oppositely with varistor layers therebetween, at least one first electrode portion disposed on one surface of the laminated chip and connected to the first conductor layers, at least one second electrode portion disposed on the one surface of the laminated chip and connected to the second conductor layers while the second electrode portion is in no contact with the first electrode portion, and at least one heat conductor portion disposed on at least one of the surfaces different from the one surface of the laminated chip and connected to at least the first conductor layers or the second conductor layers.

According to the above-described laminated varistor and the mounting structure of laminated varistor, when the heat from the exothermic device is transferred to each conductor layer via each electrode portion or when heat generation occurs as a current passes through a varistor layers, the heat is directly transferred from at least the first conductor layers or the second conductor layers to the heat conductor portion, and is released to the outside from the heat conductor portion.

On the other hand, a varistor module according to an another aspect of the present invention includes a conductor sheet in a predetermined shape and a plurality of laminated varistors provided with a rectangular parallelepiped laminated chip including a plurality of first conductor layers and a plurality of second conductor layers disposed alternately and oppositely with varistor layers therebetween, at least one first electrode portion disposed on one surface of the laminated chip and connected to the first conductor layers, and at least one second electrode portion disposed on the one surface of the laminated chip and connected to the second conductor layers while the second electrode portion is in no contact with the first electrode portion, wherein the varistor module has a configuration in which the laminated varistors are disposed in a predetermined array on a conductor sheet in such a way that a surface different from the one surface of the laminated chip of each laminated varistor is faced toward the conductor sheet and at least the first conductor layers or the second conductor layers are connected to the conductor sheet.

As for the above-described varistor module, a plurality of laminated varistors can be mounted on a substrate by one operation taking advantage of the conductor sheet. When the heat from the exothermic device is transferred to each conductor layer via each electrode portion or when heat generation occurs as a current passes through varistor layers, the heat is directly transferred from at least the first conductor layers or the second conductor layers to the heat conductor portion, and is released to the outside from the heat conductor portion.

According to the present invention, a laminated varistor having excellent radiation capability, a mounting structure of laminated varistor, and a varistor module can be provided.

### BRIEF DESCRIPTION OF THE DRAWINGS

FIGS. 1A and 1B are perspective views of a laminated varistor according to a first embodiment, viewed from the top surface side and the bottom surface side, respectively.

FIGS. 2A and 2B are sectional views of sections taken along lines b1-b1 and b2-b2, respectively, shown in FIG. 1A.

FIGS. 3A and 3B are sectional views of sections taken along lines b3-b3 and b4-b4, respectively, shown in FIG. 2A.

FIG. 4A is a diagram in which a first electrode portion, a second electrode portion, and a heat conductor portion are eliminated from FIG. 1A, and FIG. 4B is a diagram in which the first electrode portion, the second electrode portion, and the heat conductor portion are eliminated from FIG. 1B.

FIG. 5 is an explanatory diagram of a production method of the laminated varistor shown in FIGS. 1A and 1B.

FIG. 6 is an explanatory diagram of the production method of the laminated varistor shown in FIGS. 1A and 1B.

FIG. 7 is an explanatory diagram of the production method of the laminated varistor shown in FIGS. 1A and 1B.

FIG. 8 is an explanatory diagram of the production method of the laminated varistor shown in FIGS. 1A and 1B.

FIG. 9 is an explanatory diagram of the production method of the laminated varistor shown in FIGS. 1A and 1B.

FIG. 10 is an explanatory diagram of a mounting method of the laminated varistor shown in FIGS. 1A and 1B.

FIGS. 11A to 11D are vertical sectional views showing modified examples of a heat conductor portion.

FIG. 12 is a vertical sectional view showing a modified example of a heat conductor portion in the case where at least two laminated varistors are mounted side by side on a substrate.

FIG. 13 is a vertical sectional view showing another modified example of a heat conductor portion in the case where at least two laminated varistors are mounted side by side on a substrate.

FIG. 14 is a vertical sectional view showing another modified example of a heat conductor portion in the case where at least two laminated varistors are mounted side by side on a substrate.

FIG. 15 is a vertical sectional view showing another modified example of a heat conductor portion in the case where at least two laminated varistors are mounted side by side on a substrate.

FIG. 16 is a perspective view showing a varistor module.

FIG. 17 is a perspective view showing a modified example of the varistor module shown in FIG. 16.

FIG. 18 is a perspective view showing another modified example of the varistor module shown in FIG. 16.

FIG. 19 is a perspective view showing another modified example of the varistor module shown in FIG. 16.

FIG. 20 is a vertical sectional view showing a modified example of the laminated varistor shown in FIGS. 1A and 1B.

FIG. 21 is a vertical sectional view of a laminated varistor according to a second embodiment.

FIG. 22A is a perspective view of a laminated varistor according to a third embodiment, and FIG. 22B is a perspective view showing a modified example thereof.

FIG. 23A is a perspective view of a laminated varistor according to a fourth embodiment, and FIGS. 23B and 23C are perspective views showing modified examples thereof.

FIG. 24A is a vertical sectional view of a laminated varistor according to a fifth embodiment, and FIGS. 24B to 24D are vertical sectional views showing modified examples thereof.

FIGS. 25A and 25B are a perspective view and a vertical sectional view, respectively, of a laminated varistor according to a sixth embodiment, and FIGS. 25C to 25F are perspective views showing modified examples thereof.

FIGS. 26A and 26B are a perspective view and a vertical sectional view, respectively, of a laminated varistor according to a seventh embodiment, and FIGS. 26C to 26E are perspective views showing modified examples thereof.

FIGS. 27A and 27B are a perspective view and a vertical sectional view, respectively, of a laminated varistor according to an eighth embodiment, and FIGS. 27C to 27E are vertical sectional views showing modified examples thereof.

FIGS. 28A to 28C are a perspective view and vertical sectional views, respectively, of a laminated varistor according to a ninth embodiment, and FIGS. 28D and 28E are a vertical sectional view and a perspective view, respectively, showing modified examples thereof.

FIGS. 29A to 29C are a perspective view and vertical sectional views, respectively, of a laminated varistor according to a tenth embodiment, and FIG. 29D is a perspective view showing a modified example thereof.

FIGS. 30A and 30B are perspective views of a laminated varistor according to an eleventh embodiment, viewed from the top surface side and the bottom surface side, respectively.

FIGS. 31A and 31B are sectional views of sections taken along lines c1-c1 and c2-c2, respectively, shown in FIG. 30A.

FIGS. 32A and 32B are sectional views of sections taken along lines c3-c3 and c4-c4, respectively, shown in FIG. 31A.

FIG. 33 is an explanatory diagram of a production method of the laminated varistor shown in FIGS. 30A and 30B.

FIG. 34 is an explanatory diagram of the production method of the laminated varistor shown in FIGS. 30A and 30B.

FIG. 35 is an explanatory diagram of the production method of the laminated varistor shown in FIGS. 30A and 30B.

FIG. 36 is an explanatory diagram of the production method of the laminated varistor shown in FIGS. 30A and 30B.

FIG. 37 is an explanatory diagram of the production method of the laminated varistor shown in FIGS. 30A and 30B.

FIG. 38 is an explanatory diagram of a mounting method of the laminated varistor shown in FIGS. 30A and 30B.

FIG. 39 is a vertical sectional view showing a modified example of the laminated varistor shown in FIGS. 30A and 30B.

FIG. 40 is a vertical sectional view showing another modified example of the laminated varistor shown in FIGS. 30A and 30B.

### DESCRIPTION OF CERTAIN EMBODIMENTS

The above-described objects, features of the construction, operations and effects of the present invention will be made clear from the following explanation and attached drawings.

The embodiments of a laminated varistor, a mounting method of the laminated varistor and a varistor module according to the present invention will be described below with reference to drawings.

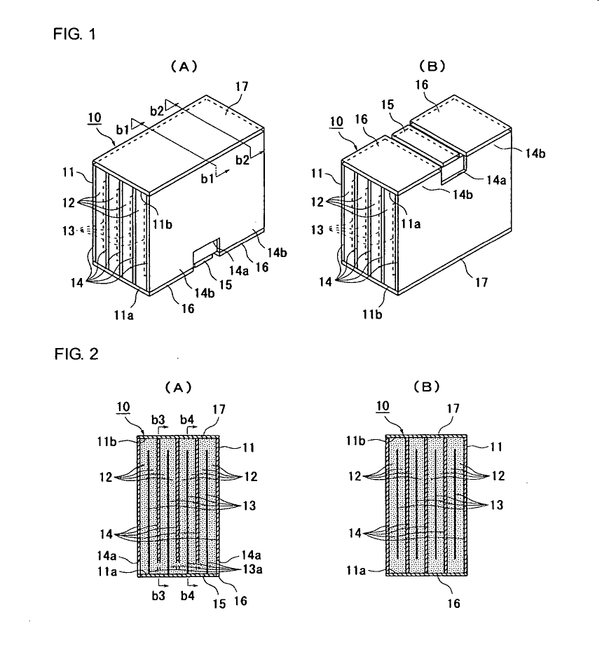

FIG. 1A to FIG. 4B show a laminated varistor according to the first embodiment.

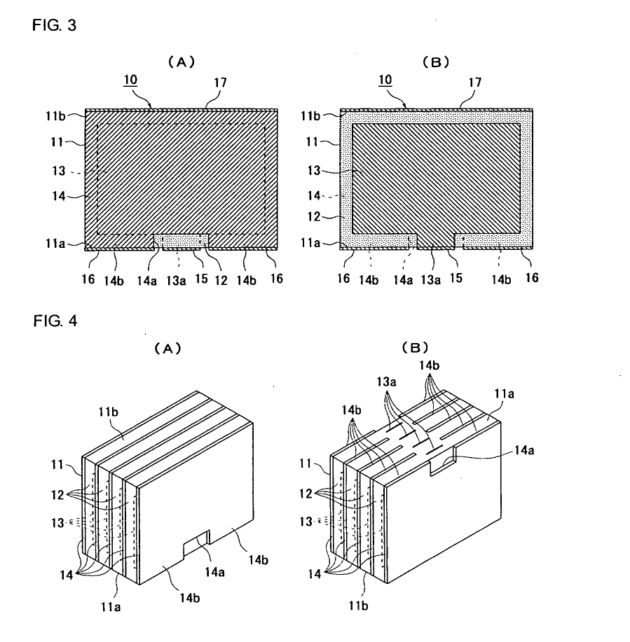

In this regard, FIG. 1A is a perspective view of a laminated varistor viewed from the top surface side, and FIG. 1B is a perspective view of the laminated varistor viewed from the bottom surface side. FIG. 2A is a sectional view of a section taken along a line b1-b1 shown in FIG. 1A, and FIG. 2B is a sectional view of a section taken along a line b2-b2 shown in FIG. 1A. FIG. 3A is a sectional view of a section taken along a line b3-b3 shown in FIG. 2A, and FIG. 3B is a sectional view of a section taken along a line b4-b4 shown in FIG. 2A. FIG. 4A is a diagram in which a first electrode portion, a second electrode portion, and a heat conductor portion are eliminated from FIG. 1A, and FIG. 4B is a diagram in which the first electrode portion, the second electrode portion, and the heat conductor portion are eliminated from FIG. 1B.

This laminated varistor 10 is provided with a rectangular parallelepiped laminated chip 11. This laminated chip 11 has a configuration in which a plurality of (four layers in the drawing) first conductor layers 13 and a plurality of (five layers in the drawing) second conductor layers 14 are disposed alternately and oppositely in a lateral direction with varistor layers 12 therebetween.

Each first conductor layer 13 is in the shape of a rectangle a size smaller than the second conductor layer 14, and includes a lead portion 13a having a predetermined width at the center of the bottom end thereof. The end of each lead portion 13a is exposed at the bottom surface 11a of the laminated chip 11. The shape and the position of disposition of this lead portion 13a are not specifically limited as long as the lead portion 13a can be connected to a first electrode portion 15 described below. The top end of each first conductor layer 13 is located inside and at a distance from the top surface 11b of the laminated chip 11. Both side edges of each first conductor layer 13 are located inside and at a distance from two side surfaces in a direction orthogonal to the lamination direction of the conductor layers of the laminated chip 11.

Each second conductor layer 14 is in the shape of substantially the same rectangle as the side surface in the lamination direction of the conductor layers of the laminated chip 11. Each second conductor layer 14 has a cut-out portion 14a at the center of the bottom end thereof and total two predetermined lead portions 14b on both sides of the cut-out portion. The cut-out portion has the depth substantially equal to the vertical length of the lead portion 13a, and a width larger than the width of the lead portion 13a. The end of each lead portion 14b is exposed at the bottom surface 11a of the laminated chip 11 while being in no contact with the end of the lead portion 13a. The shape and the position of disposition of this lead portion 14b are not specifically limited as long as the lead portion 14b can be connected to a second electrode portion 16 described below. The top end of each second conductor layer 14 is exposed at the top surface 11b of the laminated chip 11. Both side edges of each second conductor layer 14 are exposed at two side surfaces in a direction orthogonal to the lamination direction of the conductor layers of the laminated chip 11. Furthermore, the second conductor layer 14 is located at each of two side surfaces in the lamination direction of the conductor layers of the laminated chip 11.

The first electrode portion 15 connected to the end of the lead portion 13a of each first conductor layer 13 exposed at the bottom surface 11a of the laminated chip 11 is disposed on the bottom surface 11a. The first electrode portion 15 is in the shape of a belt in the lamination direction of the conductor layers of the laminated chip 11 and has a width substantially equal to the exposure width of the lead portion 13a.

Two second electrode portions 16 connected to their respective ends of the lead portions 14a of each second conductor layer 14 exposed at the bottom surface 11a of the laminated chip 11 are disposed on the bottom surface 11a. The second electrode portion is in the shape of a belt in the lamination direction of the conductor layers of the laminated chip 11 and has a width substantially equal to the exposure width of the lead portion 14a, while the second electrode portion is in no contact with the first electrode portion 15.

Furthermore, a heat conductor portion 17 connected to the top end of each second conductor layer 14 exposed at the top surface 11b of the laminated chip 11 is disposed on the top surface 11b while covering all over the top surface 11b. As is clear from a production method described below, this heat conductor portion 17 is made of a conductor coating.

In the above-described laminated varistor 10, the end of the lead portion 13a of each first conductor layer 13 is connected to one first electrode portion 15 disposed on the bottom surface 11a of the laminated chip 11, and the end of the lead portion 14a of each second conductor layer 14 is connected to two second electrode portions 16 disposed on the bottom surface 11a of the laminated chip 11. Since the top end of each second conductor layer 14 is connected to the heat conductor portion 17 disposed on the top surface 11b of the laminated chip 11, a predetermined capacitance can be attained between the first electrode portion 15 and the second electrode portions 16 disposed on the bottom surface 11a of the laminated chip 11.

Here, an example of a method for producing the above-described laminated varistor 10 will be described with reference to FIG. 5 to FIG. 9.

In the production, sheets S1 and S2 shown in FIG. 5 are prepared. A green sheet is produced by applying and drying a predetermined thickness of ceramic slurry containing a semiconductor ceramic powder, e.g., zinc oxide, and a conductor paste containing a metal powder, e.g., silver or nickel, is printed on the green sheet through the use of a screen or the like, followed by drying, to produce a conductor pattern P1 for the second conductor layer 14, so that the sheet S1 is prepared. A green sheet is produced by applying and drying a predetermined thickness of ceramic slurry containing a semiconductor ceramic powder, e.g., zinc oxide, and a conductor paste containing a metal powder, e.g., silver or nickel, is printed on the green sheet through the use of a screen or the like, followed by drying, to produce a conductor pattern P2 for the first conductor layer 13, so that the sheet S2 is prepared.

In this regard, for convenience in illustration, 32 units are taken from the sheets S1 and S2 shown in the drawing. However, the number of units to be taken practically from the sheets S1 and S2 is larger than this.

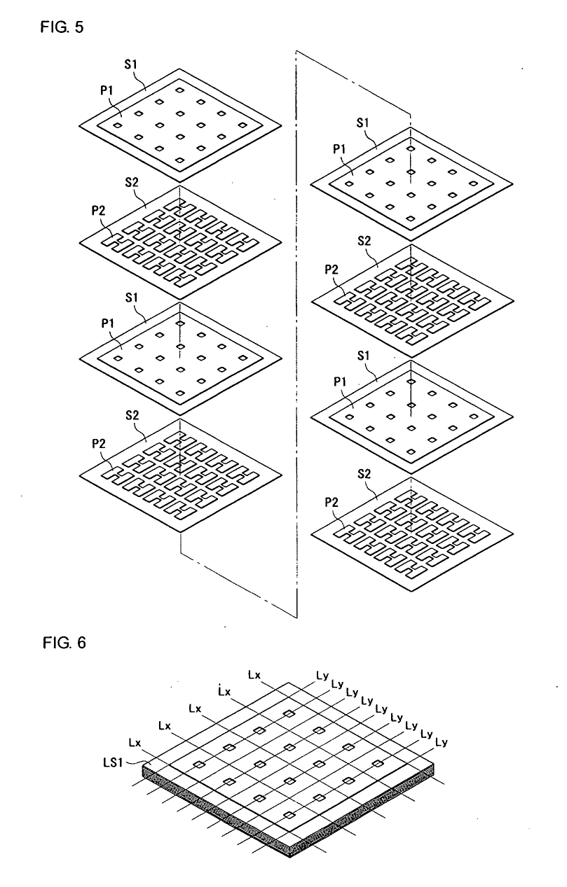

The above-described sheets S1 and S2 are laminated in the order shown in FIG. 5, and are pressure-bonded, so that a laminated sheet LS1 shown in FIG. 6 is produced.

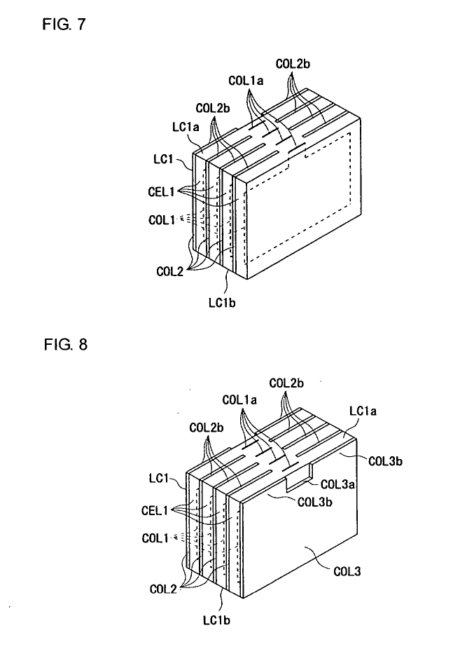

The laminated sheet LS1 is cut along the lines Lx and Ly shown in FIG. 6 and, thereby, laminated chips LC1 shown in FIG. 7 are produced.

This laminated chip LC1 has a configuration in which four unfired conductor layers COLL for serving as the first conductor layers 13 and four unfired conductor layers COL2 for serving as the second conductor layers 14 are disposed alternately and oppositely in a lateral direction with unfired varistor layers CEL1 therebetween. The end of a lead portion COL1a of each unfired conductor layer COL1 is exposed at the bottom surface LC1a of the laminated chip LC1. The end of a lead portion COL2b of each unfired conductor layer COL2 is exposed at the bottom surface LC1a of the laminated chip LC1, and the top end of each unfired conductor layer COL2 is exposed at the top surface LC1b of the laminated chip LC1.

As shown in FIG. 8, a conductor paste similar to that in the above description is applied to one side surface (the side surface at which the unfired varistor layer is exposed) in the lamination direction of the above-described laminated chip LC1 to take the same shape as the unfired conductor layer COL2, followed by drying, so that an unfired conductor layer COL3 for serving as remaining one second conductor layer 14 is formed. This unfired conductor layer COL3 is in the same shape as that of the unfired conductor layer COL2 but has a cut-out portion COL3a at the center of the bottom end thereof and lead portions COL3b on both sides thereof.

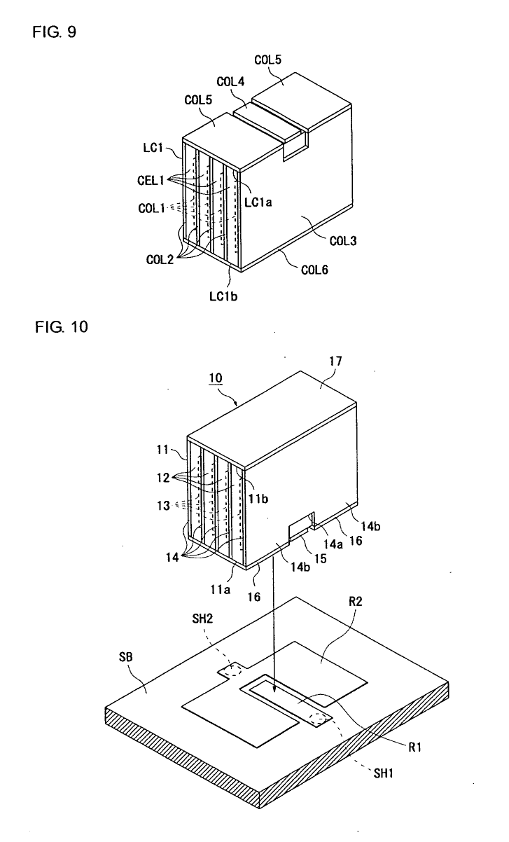

As shown in FIG. 9, a conductor paste similar to that in the above description is applied to the center of the bottom surface of the above-described laminated chip LC1 to take the shape of a belt, followed by drying, so that an unfired electrode portion COL4 for serving as the first electrode portion 15 is formed. In addition, a conductor paste similar to that in the above description is applied to both sides of the bottom surface of the laminated chip LC1 to take the shape of a belt, followed by drying, so that unfired electrode portions COL5 for serving as the second electrode portions 16 are formed. Furthermore, a conductor paste similar to that in the above description is applied all over the top surface of the laminated chip LC1, followed by drying, so that an unfired conductor portion COL6 for serving as the heat conductor portion 17 is formed.

Subsequently, a plurality of laminated chips LC1 shown in FIG. 9 are fired by one operation. As described above, the laminated varistors 10 are produced.

In the above-described production method, the unfired conductor layer COL3 for serving as the remaining one second conductor layer 14, the unfired electrode portion COL4 for serving as the first electrode portion 15, the unfired electrode portions COL5 for serving as the second electrode portions 16, and the unfired conductor portion COL6 for serving as the heat conductor portion 17 are formed on the laminated chip LC1 shown in FIG. 7, and these are fired simultaneously with the laminated chip LC 1. However, only the laminated chip LC1 shown in FIG. 7 may be fired, the unfired conductor layer COL3, the unfired electrode portion COL4, the unfired electrode portions COL5, and the unfired conductor portion COL6 may be formed sequentially on the resulting laminated chip LC1, and a firing treatment may be performed.

In the above-described production method, the remaining one second conductor layer 14, the first electrode portion 15, the second electrode portions 16, and the heat conductor portion 17 are formed by a thick film forming method through application of the paste and firing. However, at least one of them may be formed by a thin film forming method, e.g., electrolytic plating or sputtering.

As shown in FIG. 10, the above-described laminated varistor 10 can be mounted on a substrate SB having lands R1 and R2 corresponding to the first electrode portion 15 and the second electrode portions 16, respectively, in such a way that the bottom surface 11a of the laminated chip 11 is faced toward a substrate mounting surface, one first electrode portion 15 is connected to the land R1, and two second electrode portions 16 are connected to the land R2.

In this regard, in the substrate SB shown in FIG. 10, one of the land R1 and the land R2 serves as a positive electrode and the other serves as a ground electrode, a wiring of the land R1 is routed to a back of the substrate via a through hole SH1, and a wiring of the other land R2 is routed to the back of the substrate via a through hole SH2.

In the above-described laminated varistor 10 and a structure (mounting structure) in which the laminated varistor 10 is mounted on the substrate SB, when the heat from an exothermic device, e.g., an IC, disposed in the vicinity is transferred to each of the first conductor layers 13 and the second conductor layers 14 via the substrate SB, lands R1 and R2, the first electrode portion 15, and the second electrode portions 16 or when heat generation occurs as a current passes through the varistor layers 12, the heat is directly and highly efficiently transferred from each second conductor layer 14 to the heat conductor portion 17, and is effectively released to the outside from the heat conductor portion 17.

Since the heat conductor portion 17 is disposed covering all over the top surface of the laminated chip 11, an area to release the heat to the outside can be adequately ensured, and the heat radiation can be performed effectively.

Furthermore, the second conductor layer 14 is exposed at each of two side surfaces in the lamination direction of the conductor layers of the laminated chip 11. In addition, both side edges of each second conductor layer 14 are exposed at two side surfaces in a direction orthogonal to the lamination direction of the conductor layers of the laminated chip 11. Consequently, these exposed portions are made to perform the function similar to that of the heat conductor portion and, thereby, the above-described heat radiation action can be facilitated.

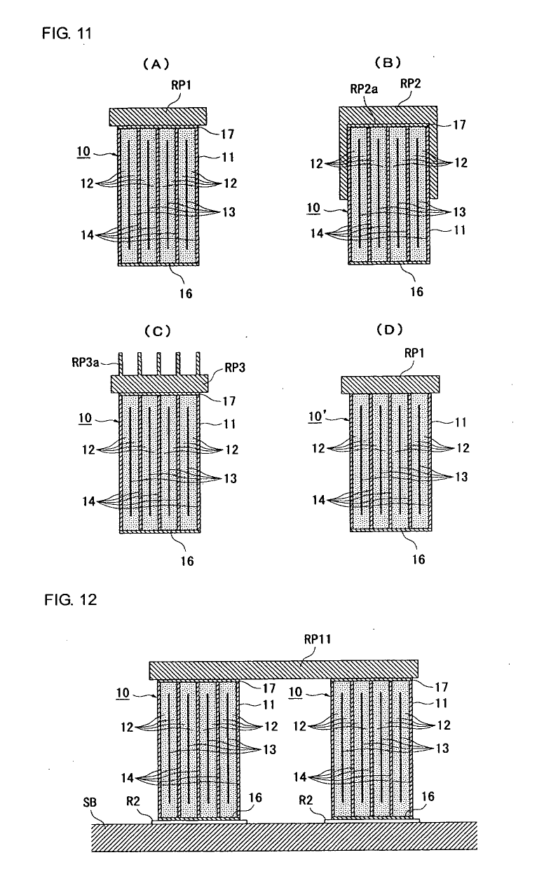

The above-described laminated varistor 10 is provided with the heat conductor portion 17 made of the conductor coating. However, as shown in FIG. 11A, a conductor sheet (heatsink) RP1 made of a high-thermal-conductivity metal, e.g., aluminum, may be connected to the conductor coating 17 to constitute the heat conductor portion.

This conductor sheet may be a flat-shaped sheet. In addition, a conductor sheet having a concave portion RP2a to receive a part of the laminated chip 11, as shown in FIG. 11B, or a conductor sheet RP3 having a plurality of fins RP3a, as shown in FIG. 11C, may be used. Alternatively, as shown in FIG. 11D, the above-described conductor coating 17 can be eliminated from the configuration of a laminated varistor 10′ by disposing a conductor sheet RP1 connected to the top end of each second conductor layer 14.

In the case where at least two laminated varistors 10 are mounted side by side on the substrate SB, as shown in FIG. 12, a shared conductor sheet (heatsink) RP11 made of a high-thermal-conductivity metal, e.g., aluminum, may be connected to conductor coatings 17 of a plurality of laminated varistors 10. The shared conductor sheet RP11 has a shape in accordance with the arrangement form of at least two laminated varistors 10 mounted side by side on the substrate SB.

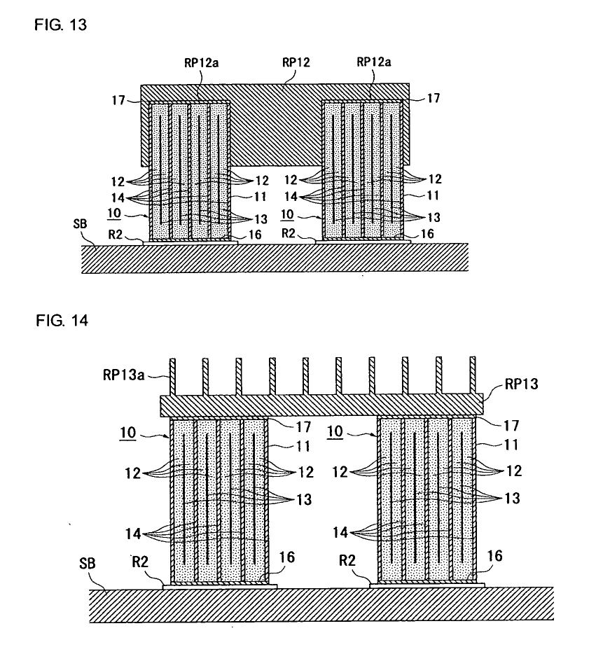

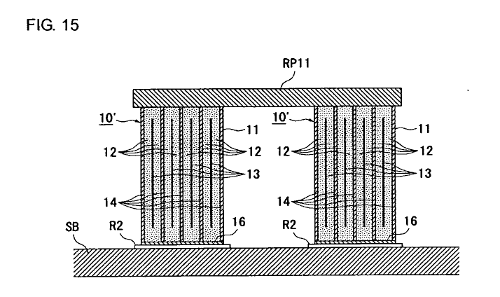

This shared conductor sheet may be a flat-shaped sheet. In addition, a shared conductor sheet RP12 having a plurality of concave portions RP12a to receive a part of each laminated chip 11, as shown in FIG. 13, or a shared conductor sheet RP13 having a plurality of fins RP13a, as shown in FIG. 14, may be used. Alternatively, as shown in FIG. 15, laminated varistors 10′ having a configuration in which the above-described conductor coating 17 is eliminated may be used by disposing a conductor sheet RP11 connected to the top end of each second conductor layer 14 of the plurality of laminated varistors 10.

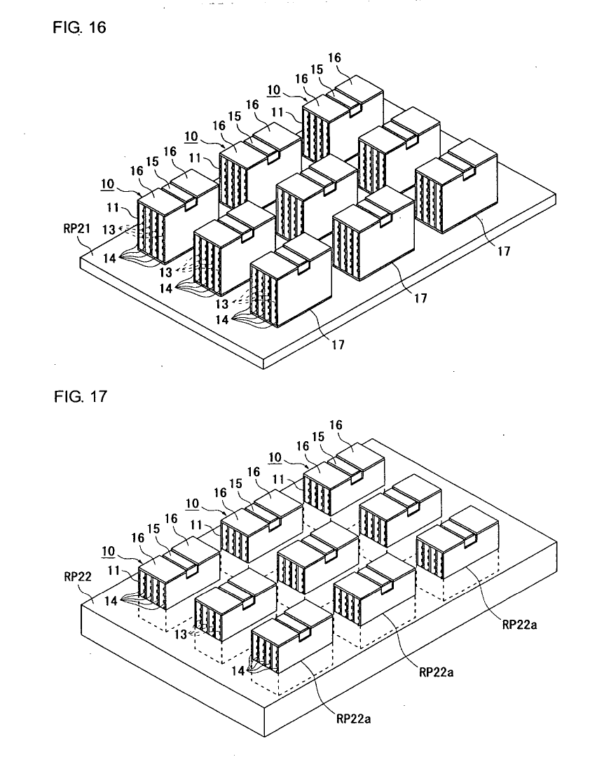

In the case where at least two laminated varistors 10 are mounted side by side on the substrate, the mounting on the substrate can be simply conducted by forming a varistor module, as shown in FIG. 16, in advance.

The varistor module shown in FIG. 16 is constructed by disposing a plurality of laminated varistors 10 in a predetermined array in such a way that each conductor coating 17 is connected to one surface of a conductor sheet (heatsink) RP21 made of a high-thermal-conductivity metal, e.g., aluminum. Therefore, in the mounting to a substrate, the plurality of laminated varistors 10 can be mounted on the substrate by one operation through the use of the conductor sheet RP21. The heat radiation action after the mounting is as described above.

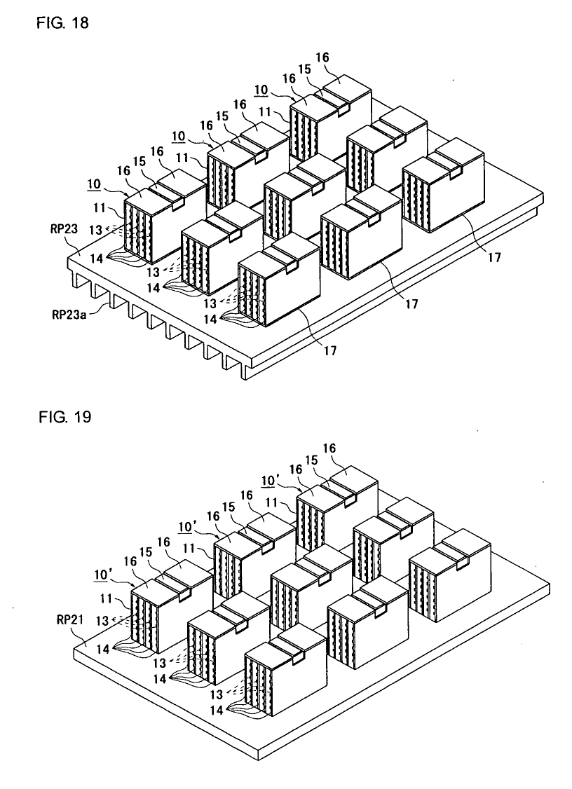

This conductor sheet may be a flat-shaped sheet. In addition, a conductor sheet RP22 may have a plurality of concave portions RP22a in a predetermined array to receive a part of each laminated chip 11, as shown in FIG. 17, or a conductor sheet RP23 having a plurality of fins RP23a on the opposite surface, as shown in FIG. 18, may be used. Alternatively, as shown in FIG. 19, laminated varistors 10′ having a configuration in which the above-described conductor coating 17 is eliminated may be used by disposing the plurality of laminated varistors 10 in such a way that the top end of each second conductor layer 14 thereof is connected to one surface of the conductor sheet RP21.

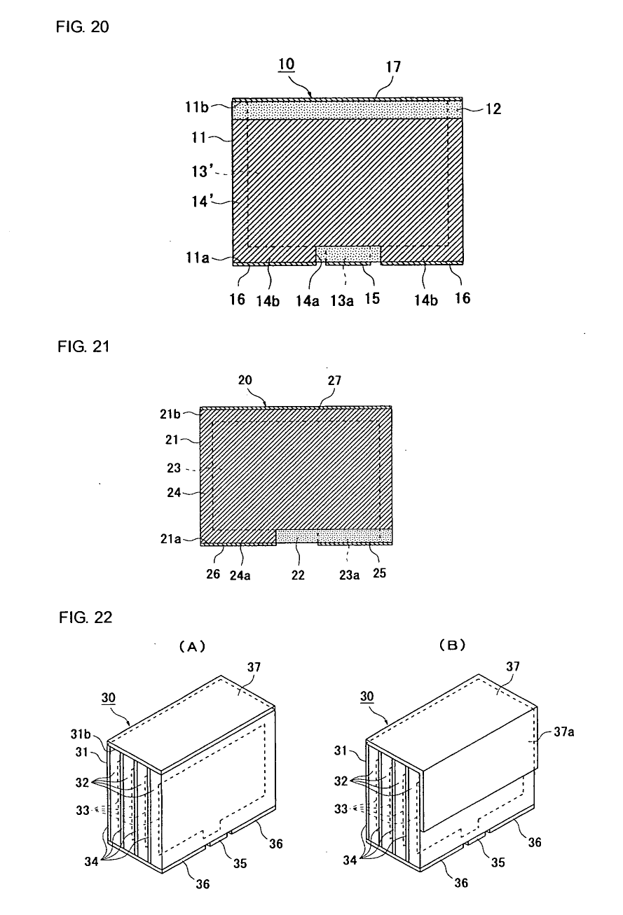

In the above-described laminated varistor 10, the top end of each second conductor layer 14 is exposed at the top surface 11b of the laminated chip 11 and is connected to the heat conductor portion 17. However, as shown in FIG. 20, the top end of each second conductor layer 14′ may be located inside and at a distance from the top surface 11b of the laminated chip 11. In addition, the top end of each first conductor layer 13′ may be exposed at the top surface 11b of the laminated chip 11, and this may be connected to the heat conductor portion 17. In this manner, the heat radiation function as described above can also be attained.

Other embodiments related to laminated varistors capable of replacing the laminated varistor 10 shown in FIG. 1A to FIG. 4B will be described below with reference to FIG. 21 to FIG. 40.

FIG. 21 shows a laminated varistor according to the second embodiment.

In this regard, in FIG. 21, reference numeral 20 denotes a laminated varistor, reference numeral 21 denotes a laminated chip, reference numeral 21a denotes a bottom surface of the laminated chip, reference numeral 21b denotes a top surface of the laminated chip, reference numeral 22 denotes a varistor layer, reference numeral 23 denotes a first conductor layer, reference numeral 23a denotes a lead portion, reference numeral 24 denotes a second conductor layer, reference numeral 24a denotes a lead portion, reference numeral 25 denotes a first electrode portion, reference numeral 26 denotes a second electrode portion, and reference numeral 27 denotes a heat conductor portion.

This laminated varistor 20 is different from the above-described laminated varistor 10 in that one each of the first electrode portion 25 and the second electrode portion 26 is disposed and one each of the lead portions 23a and 24a of the conductor layers 23 and 24, respectively, is disposed.

According to this laminated varistor 20, a heat radiation effect similar to that in the above-described laminated varistor 10 can be attained by transferring the heat of each second conductor layer 24 to the heat conductor portion 27 directly and highly efficiently.

FIG. 22A shows a laminated varistor according to the third embodiment.

In this regard, in FIG. 22A, reference numeral 30 denotes a laminated varistor, reference numeral 31 denotes a laminated chip, reference numeral 31a denotes a bottom surface of the laminated chip, reference numeral 31b denotes a top surface of the laminated chip, reference numeral 32 denotes a varistor layer, reference numeral 33 denotes a first conductor layer, reference numeral 34 denotes a second conductor layer, reference numeral 35 denotes a first electrode portion, reference numeral 36 denotes a second electrode portion, and reference numeral 37 denotes a heat conductor portion.

This laminated varistor 30 is different from the above-described laminated varistor 10 in that the second conductor layer located on one side surface in the lamination direction of the conductor layers of the laminated chip 31 is eliminated and the varistor layer 32 is exposed at the one side surface.

According to this laminated varistor 30, a heat radiation effect similar to that in the above-described laminated varistor 10 can be attained by transferring the heat of each second conductor layer 34 to the heat conductor portion 37 directly and highly efficiently.

In this laminated varistor 30, since the varistor 32 is exposed at the one side surface in the lamination direction of the conductor layers of the laminated chip 31, a wraparound portion 37a can be disposed to extend continuously from the heat conductor portion 37 made of a conductor coating to the one side surface, as shown in FIG. 22B. In this manner, the heat radiation area of the heat conductor portion 37 can be increased and the heat radiation can be conducted more effectively. In this case, the above-described conductor sheet (heatsink) can be connected to the wraparound portion 37a of the heat conductor portion 37 as well.

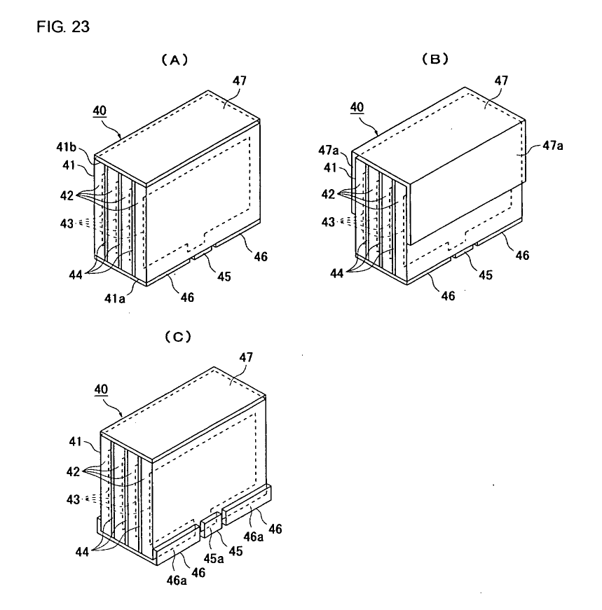

FIG. 23A shows a laminated varistor according to the fourth embodiment.

In this regard, in FIG. 23A, reference numeral 40 denotes a laminated varistor, reference numeral 41 denotes a laminated chip, reference numeral 41a denotes a bottom surface of the laminated chip, reference numeral 41b denotes a top surface of the laminated chip, reference numeral 42 denotes a varistor layer, reference numeral 43 denotes a first conductor layer, reference numeral 44 denotes a second conductor layer, reference numeral 45 denotes a first electrode portion, reference numeral 46 denotes a second electrode portion, and reference numeral 47 denotes a heat conductor portion.

This laminated varistor 40 is different from the above-described laminated varistor 10 in that the second conductor layers located on both side surfaces in the lamination direction of the conductor layers of the laminated chip 41 are eliminated and the varistor layers 42 are exposed at both the side surfaces.

According to this laminated varistor 40, a heat radiation effect similar to that in the above-described laminated varistor 10 can be attained by transferring the heat of each second conductor layer 44 to the heat conductor portion 47 directly and highly efficiently.

In this laminated varistor 40, since the varistor layers 42 are exposed at both the side surfaces in the lamination direction of the conductor layers of the laminated chip 41, wraparound portions 47a can be disposed to extend continuously from the heat conductor portion 47 made of a conductor coating to both the side surfaces, as shown in FIG. 23B. In this manner, the heat radiation area of the heat conductor portion 47 can be increased and the heat radiation can be conducted more effectively. In this case, the above-described conductor sheet (heatsink) can be connected to at least one of the wraparound portions 47a of the heat conductor portion 47 as well.

Furthermore, in this laminated varistor 40, since the varistor layers 42 are exposed at both the side surfaces in the lamination direction of the conductor layers of the laminated chip 41, wraparound portions 45a and 46a can be disposed to extend continuously from the first electrode portion 45 and the second electrode portions 46, respectively, to both the side surfaces in both directions, as shown in FIG. 23C. In this manner, the adhesion area of a jointing material can be increased in the mounting of the laminated varistor 40 to a substrate by using the jointing material, e.g., solder, and thereby, the connection strength can be increased.

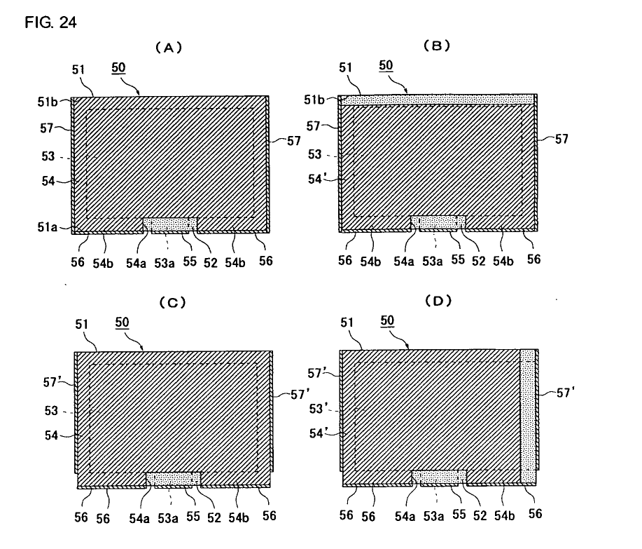

FIG. 24A shows a laminated varistor according to the fifth embodiment.

In this regard, in FIG. 24A, reference numeral 50 denotes a laminated varistor, reference numeral 51 denotes a laminated chip, reference numeral 51a denotes a bottom surface of the laminated chip, reference numeral 51b denotes a top surface of the laminated chip, reference numeral 52 denotes a varistor layer, reference numeral 53 denotes a first conductor layer, reference numeral 54 denotes a second conductor layer, reference numeral 53a denotes a lead portion, reference numeral 54a denotes a cut-out portion, reference numeral 54b denotes a lead portion, reference numeral 55 denotes a first electrode portion, reference numeral 56 denotes a second electrode portion, and reference numeral 57 denotes a heat conductor portion.

This laminated varistor 50 is different from the above-described laminated varistor 10 in that the heat conductor portion is eliminated from the top surface of the laminated chip 51, the heat conductor portions 57 made of a conductor coating are disposed on two side surfaces in a direction orthogonal to the lamination direction of the conductor layers of the laminated chip 51 while covering all over the side surfaces and are connected to the side edges of the second conductor layers 54, and the bottom end of each heat conductor portion 57 is connected to the second electrode portion 56.

According to this laminated varistor 50, a heat radiation effect similar to that in the above-described laminated varistor 10 can be attained by transferring the heat of each second conductor layer 54 to the heat conductor portion 57 directly and highly efficiently.

In this ceramic varistor 50, a similar heat radiation effect can be attained when the top end of each second conductor layer 54′ is located inside and at a distance from the top surface 51b of the laminated chip 51, as shown in FIG. 24B.

In this ceramic varistor 50, a similar heat radiation effect can be attained when each heat conductor portion 57′ is disposed in such a way that the bottom end thereof is in no contact with the second electrode portion 56, as shown in FIG. 24C.

Furthermore, in the case where a form of a heat conductor portion 57′ shown in FIG. 24C is adopted, as shown in FIG. 24D, one side edge of a first conductor layer 53′ may be exposed at one side surface in a direction orthogonal to the lamination direction of the conductor layers of the laminated chip 51 so as to be connected to one heat conductor portion 57′, and one side edge of a second conductor layer 54′ may be exposed only at the other side surface in the direction orthogonal to the lamination direction of the conductor layers of the laminated chip 51 so as to be connected to the other heat conductor portion 57′. In this manner, the heat of each first conductor layer 53′ can be transferred to the one heat conductor portion 57′ directly and highly efficiently, and the heat of each second conductor layer 54′ can be transferred to the other heat conductor portion 57′ directly and highly efficiently, so that the heat of the varistor itself can be released to the outside more effectively.

In this laminated varistor 50 according to the fifth embodiment, the above-described conductor sheet (heatsink) can be connected to at least one of the heat conductor portions 57 or at least one of the heat conductor portions 57′ as well.

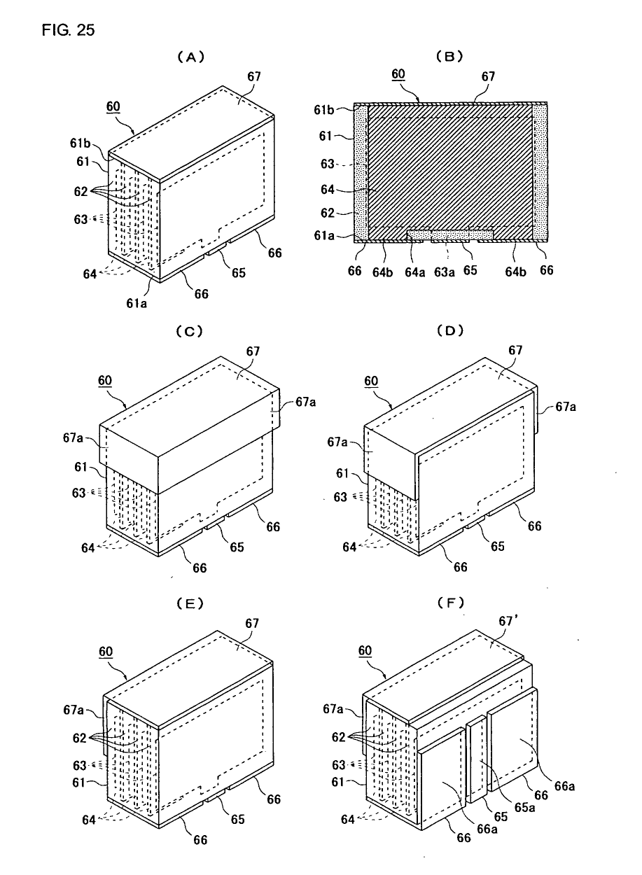

FIG. 25A and FIG. 25B show a laminated varistor according to the sixth embodiment.

In this regard, in FIG. 25A and FIG. 25B, reference numeral 60 denotes a laminated varistor, reference numeral 61 denotes a laminated chip, reference numeral 61a denotes a bottom surface of the laminated chip, reference numeral 61b denotes a top surface of the laminated chip, reference numeral 62 denotes a varistor layer, reference numeral 63 denotes a first conductor layer, reference numeral 63a denotes a lead portion, reference numeral 64 denotes a second conductor layer, reference numeral 64a denotes a cut-out portion, reference numeral 64b denotes a lead portion, reference numeral 65 denotes a first electrode portion, reference numeral 66 denotes a second electrode portion, and reference numeral 67 denotes a heat conductor portion.

This laminated varistor 60 is different from the above-described laminated varistor 10 in that the second conductor layers located on both side surfaces in the lamination direction of the conductor layers of the laminated chip 61 are eliminated and the varistor layers 62 are exposed at both the side surfaces and both the side edges of each second conductor layer 64 are located inside and at a distance from two side surfaces in a direction orthogonal to the lamination direction of the conductor layers of the laminated chip 61.

According to this laminated varistor 60, a heat radiation effect similar to that in the above-described laminated varistor 10 can be attained by transferring the heat of each second conductor layer 64 to the heat conductor portion 67 directly and highly efficiently.

In this laminated varistor 60, since the varistor layers 62 are exposed at both side surfaces in the lamination direction of the conductor layers of the laminated chip 61 and both side surfaces in a direction orthogonal to the lamination direction of the conductor layers, wraparound portions 67a can be disposed to extend continuously from the heat conductor portion 67 made of a conductor coating to four side surfaces, as shown in FIG. 25C, wraparound portions 67a can be disposed to extend continuously from the heat conductor portion 67 made of a conductor coating to two or three side surfaces, as shown in FIG. 25D, or a wraparound portion 67a can be disposed to extend continuously from the heat conductor portion 67 made of a conductor coating to one side surface, as shown in FIG. 25E. In this manner, the heat radiation area of the heat conductor portion 67 can be increased and the heat radiation can be conducted more effectively.

Furthermore, in the case where a form of the heat conductor portion 67 shown in FIG. 25E is adopted, as shown in FIG. 25F, wraparound portions 65a and 66a may be disposed to long-extend from the first electrode portion 65 and the second electrode portions 66, respectively, to the side surface on which no wraparound portion 67a is present, and the top surface portion of the heat conductor portion 67′ may be disposed at a distance from the side surface on which no wraparound portion 67a is present, so that a laminated varistor capable of being mounted in a horizontal position, in which the wraparound portions 65a and 66a of the first electrode portion 65 and the second electrode portions 66 face the mounting surface of the substrate, can be constructed as well.

In this laminated varistor 60 according to the sixth embodiment, the connection strength in the mounting on the substrate can also be improved by disposing a wraparound portion extended from each electrode portion, as described with reference to FIG. 23C. The above-described conductor sheet (heatsink) can be connected to the wraparound portions 67a of the heat conductor portions 67 or 67′ as well.

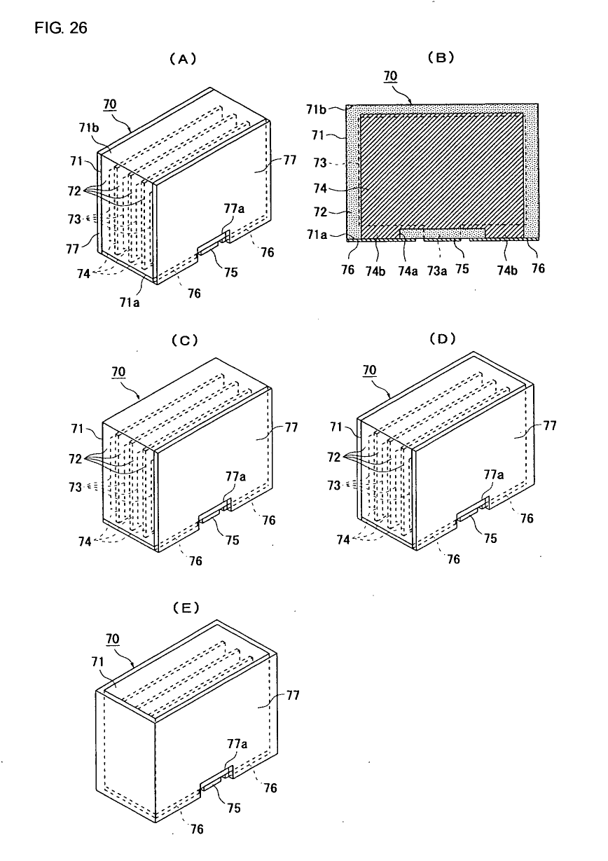

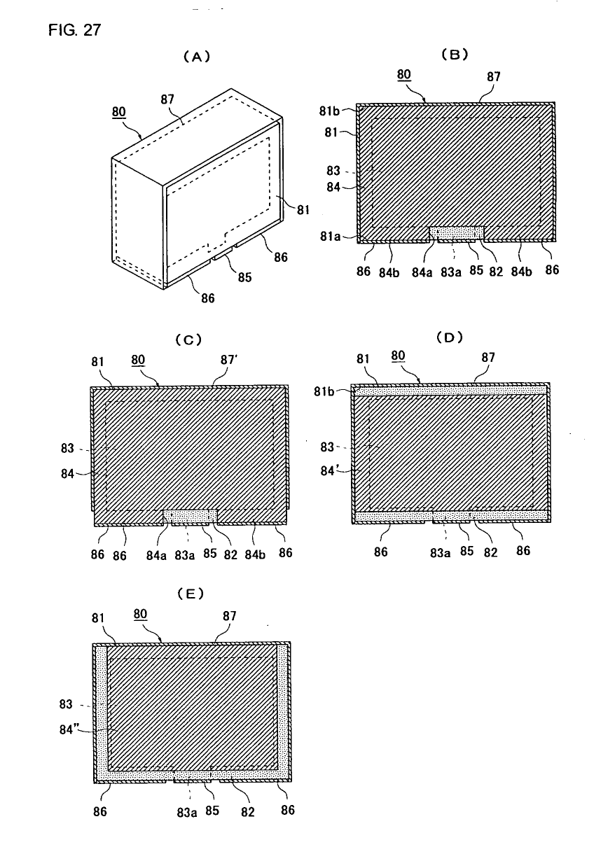

FIG. 26A and FIG. 26B show a laminated varistor according to the seventh embodiment.

In this regard, in FIG. 26A and FIG. 26B, reference numeral 70 denotes a laminated varistor, reference numeral 71 denotes a laminated chip, reference numeral 71a denotes a bottom surface of the laminated chip, reference numeral 71b denotes a top surface of the laminated chip, reference numeral 72 denotes a varistor layer, reference numeral 73 denotes a first conductor layer, reference numeral 73a denotes a lead portion, reference numeral 74 denotes a second conductor layer, reference numeral 74a denotes a cut-out portion, reference numeral 74b denotes a lead portion, reference numeral 75 denotes a first electrode portion, reference numeral 76 denotes a second electrode portion, and reference numeral 77 denotes a heat conductor portion.

This laminated varistor 70 is different from the above-described laminated varistor 10 in that the second conductor layers located on two side surfaces in the lamination direction of the conductor layers of the laminated chip 71 are eliminated and the varistor layers 72 are exposed at both the side surfaces, the heat conductor portions 77 made of a conductor coating are disposed while covering all over two respective side surfaces (except the cut-out portions 77a) in the lamination direction of the conductor layers of the laminated chip 71, the bottom end of each heat conductor portion 77 is connected to the second electrode portions 76, the top end of each second conductor layer 74 is located inside and at a distance from the top surface of the laminated chip 71, and both side edges of each second conductor layer 74 are located inside and at a distance from two side surfaces in a direction orthogonal to the lamination direction of the conductor layers of the laminated chip 71.

According to this laminated varistor 70, a heat radiation effect similar to that in the above-described laminated varistor 10 can be attained by transferring the heat of each second conductor layer 74 to the heat conductor portions 77 directly and highly efficiently.

The above-described heat conductor portion 77 may be disposed on only one side surface in the lamination direction of the conductor layers of the laminated chip 71, as shown in FIG. 26C. The heat conductor portion 77 may be disposed on two side surfaces in the lamination direction of the conductor layers of the laminated chip 71 and one side surface in a direction orthogonal to the lamination direction of the conductor layers, as shown in FIG. 26D. Alternatively, the heat conductor portion 77 may be disposed on two side surfaces in the lamination direction of the conductor layers of the laminated chip 71 and two side surfaces in a direction orthogonal to the lamination direction of the conductor layers, as shown in FIG. 26E.

In this laminated varistor 70 according to the seventh embodiment, the above-described conductor sheet (heatsink) can be connected to at least one side surface of the heat conductor portion 77 as well.

FIG. 27A and FIG. 27B show a laminated varistor according to the eighth embodiment.

In this regard, in FIG. 27A and FIG. 27B, reference numeral 80 denotes a laminated varistor, reference numeral 81 denotes a laminated chip, reference numeral 81a denotes a bottom surface of the laminated chip, reference numeral 81b denotes a top surface of the laminated chip, reference numeral 82 denotes a varistor layer, reference numeral 83 denotes a first conductor layer, reference numeral 83a denotes a lead portion, reference numeral 84 denotes a second conductor layer, reference numeral 84a denotes a cut-out portion, reference numeral 84b denotes a lead portion, reference numeral 85 denotes a first electrode portion, reference numeral 86 denotes a second electrode portion, and reference numeral 87 denotes a heat conductor portion. This laminated varistor 80 is different from the above-described laminated varistor 10 in that the second conductor layers located on two side surfaces in the lamination direction of the conductor layers of the laminated chip 81 are eliminated and the varistor layers 82 are exposed at both the side surfaces, the heat conductor portion 87 made of a conductor coating is disposed while covering all over the top surface 81b of the laminated chip 81 and all over two side surfaces in a direction orthogonal to the lamination direction of the conductor layers, side surface portions of the heat conductor portion 87 are connected to the side edges of the second conductor layers 84, and bottom ends of the side surface portions are connected to the second electrode portions 86.

According to this laminated varistor 80, a heat radiation effect similar to that in the above-described laminated varistor 10 can be attained by transferring the heat of each second conductor layer 84 to the heat conductor portion 87 directly and highly efficiently.

In this laminated varistor 80, a similar heat radiation effect can be attained when a heat conductor portion 87′ is disposed in such a way that the bottom ends of the side surface portions thereof are in no contact with the second electrode portions 86, as shown in FIG. 27C.

In this laminated varistor 80, since the bottom ends of the side surface portions of the heat conductor portion 87 are connected to the second electrode portions 86, a similar heat radiation effect can be attained even when the top end of each second conductor layer 84′ is located inside and at a distance from the top surface 81b of the laminated chip 81 and the lead electrode of each second conductor layer 84′ is eliminated, as shown in FIG. 27D. The conduction between each second electrode portion 86 and each second conductor layer 84′ in this case can be performed via the side surface portion of the heat conductor portion 87.

Furthermore, in this laminated varistor 80, since the bottom ends of the side surface portions of the heat conductor portion 87 are connected to the second electrode portions 86, a similar heat radiation effect can be attained even when the side edges of each second conductor layer 84″ are located inside and at a distance from the two side surfaces in a direction orthogonal to the lamination direction of the laminated chip 81 and the lead electrode of each second conductor layer 84″ is eliminated, as shown in FIG. 27E. The conduction between each second electrode portion 86 and each second conductor layer 84″ in this case is performed via the top surface portion and the side surface portion of the heat conductor portion 87.

In this laminated varistor 80 according to the eighth embodiment, the above-described conductor sheet (heatsink) can be connected to at least one side surface of the heat conductor portions 87 or 87′ as well.

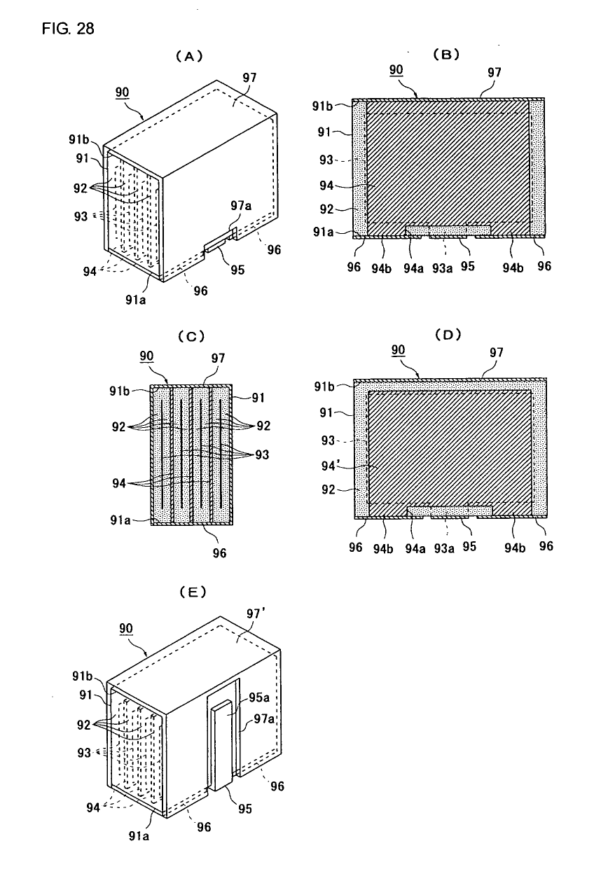

FIG. 28A to FIG. 28C show a laminated varistor according to the ninth embodiment.

In this regard, in FIG. 28A to FIG. 28C, reference numeral 90 denotes a laminated varistor, reference numeral 91 denotes a laminated chip, reference numeral 91a denotes a bottom surface of the laminated chip, reference numeral 91b denotes a top surface of the laminated chip, reference numeral 92 denotes a varistor layer, reference numeral 93 denotes a first conductor layer, reference numeral 93a denotes a lead portion, reference numeral 94 denotes a second conductor layer, reference numeral 94a denotes a cut-out portion, reference numeral 94b denotes a lead portion, reference numeral 95 denotes a first electrode portion, reference numeral 96 denotes a second electrode portion, and reference numeral 97 denotes a heat conductor portion.

This laminated varistor 90 is different from the above-described laminated varistor 10 in that the second conductor layers located on two side surfaces in the lamination direction of the conductor layers of the laminated chip 91 are eliminated and the varistor layers 92 are exposed at both the side surfaces, the heat conductor portion 97 made of a conductor coating is disposed while covering all over the top surface 91b of the laminated chip 91 and all over two side surfaces in the lamination direction of the conductor layers (except a cut-out portion 97a), bottom ends of the side surface portions of the heat conductor portion 97 are connected to the second electrode portions 96, and both side edges of each second conductor layer 94 are located inside and at a distance from the two side surfaces in a direction orthogonal to the lamination direction of the conductor layers of the laminated chip 91.

According to this laminated varistor 90, a heat radiation effect similar to that in the above-described laminated varistor 10 can be attained by transferring the heat of each second conductor layer 94 to the heat conductor portion 97 directly and highly efficiently.

In this laminated varistor 90, since the bottom ends of the side surface portions of the heat conductor portion 97 are connected to the second electrode portions 96, even when the top end of each second conductor layer 94′ is located inside and at a distance from the top surface 91b of the laminated chip 91, as shown in FIG. 28D, the heat of each second conductor layer 94′ can be transferred to the heat conductor portion 97 via the second electrode portion 96 and, thereby, a similar heat radiation effect can be attained.

In this laminated varistor 90, since the bottom ends of the side surface portions of the heat conductor portion 97 are connected to the second electrode portions 96, as shown in FIG. 28E, when a large cut-out portion 97a is disposed on one side surface portion of the heat conductor portion 97′ and a wraparound portion 95a extended from the first electrode portion 95 is disposed inside the cut-out portion 97a, a laminated varistor capable of being mounted in a horizontal position, in which the wraparound portion 95a of the first electrode portion 95 is faced toward the mounting surface of the substrate, can be constructed as well.

In this laminated varistor 90 according to the ninth embodiment, the above-described conductor sheet (heatsink) can be connected to at least one side surface of the heat conductor portions 97 or 97′ as well.

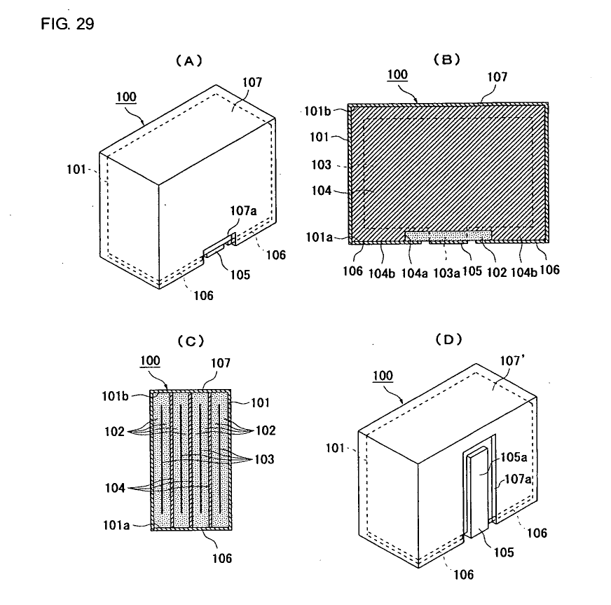

FIG. 29A to FIG. 29C show a laminated varistor according to the tenth embodiment.

In this regard, in FIG. 29A to FIG. 29C, reference numeral 100 denotes a laminated varistor, reference numeral 101 denotes a laminated chip, reference numeral 101a denotes a bottom surface of the laminated chip, reference numeral 101b denotes a top surface of the laminated chip, reference numeral 102 denotes a varistor layer, reference numeral 103 denotes a first conductor layer, reference numeral 103a denotes a lead portion, reference numeral 104 denotes a second conductor layer, reference numeral 104a denotes a cut-out portion, reference numeral 104b denotes a lead portion, reference numeral 105 denotes a first electrode portion, reference numeral 106 denotes a second electrode portion, and reference numeral 107 denotes a heat conductor portion.

This laminated varistor 100 is different from the above-described laminated varistor 10 in that the second conductor layers located on two side surfaces in the lamination direction of the conductor layers of the laminated chip 101, eliminated and the varistor layers 102 are exposed at both the side surfaces, the heat conductor portion 107 made of a conductor coating is disposed while covering all over the top surface 101b of the laminated chip 101 and all over two side surfaces in the lamination direction of the conductor layers (except a cut-out portion 107a), and all over two side surfaces in a direction orthogonal to the lamination direction of the conductor layers, and bottom ends of the side surface portions of the heat conductor portion 107 are connected to the second electrode portions 106.

According to this laminated varistor 100, a heat radiation effect similar to that in the above-described laminated varistor 10 can be attained by transferring the heat of each second conductor layer 104 to the heat conductor portion 107 directly and highly efficiently.

In this laminated varistor 100, since the bottom ends of the side surface portions of the heat conductor portion 107 are connected to the second electrode portions 106, as shown in FIG. 29D, when a large cut-out portion 107a is disposed on one side surface portion of the heat conductor portion 107′ and a wraparound portion 105a extended from the first electrode portion 105 is disposed inside the cut-out portion 107a, a laminated varistor capable of being mounted in a horizontal position, in which the wraparound portion 105a of the first electrode portion 105 is faced toward the mounting surface of the substrate, can be constructed as well.

In this laminated varistor 100 according to the tenth embodiment, the above-described conductor sheet (heatsink) can be connected to at least one side surface of the heat conductor portions 107 or 107′ as well.

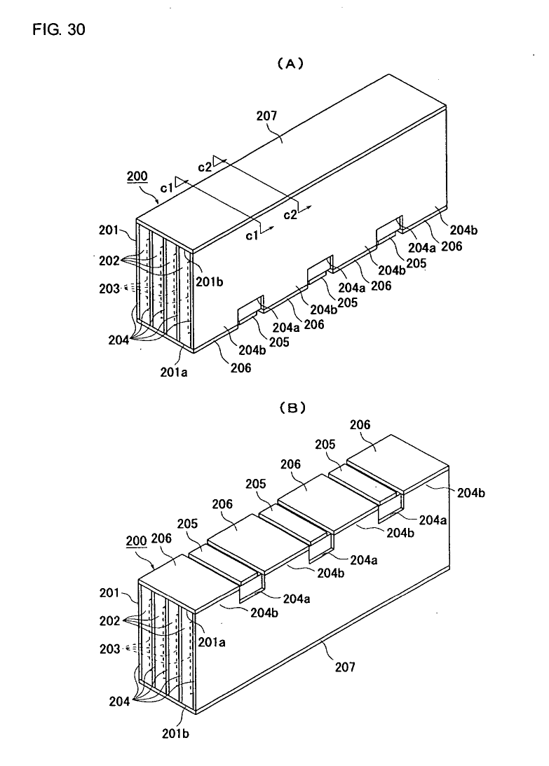

FIG. 30A to FIG. 32B show a laminated varistor according to the eleventh embodiment. This laminated varistor 200 corresponds to the laminated varistor 10 shown in FIG. 1 to FIG. 4, in which the number of the electrode portions is increased, but the basic configuration is not different from that of the laminated varistor 10 shown in FIG. 1 to FIG. 4.

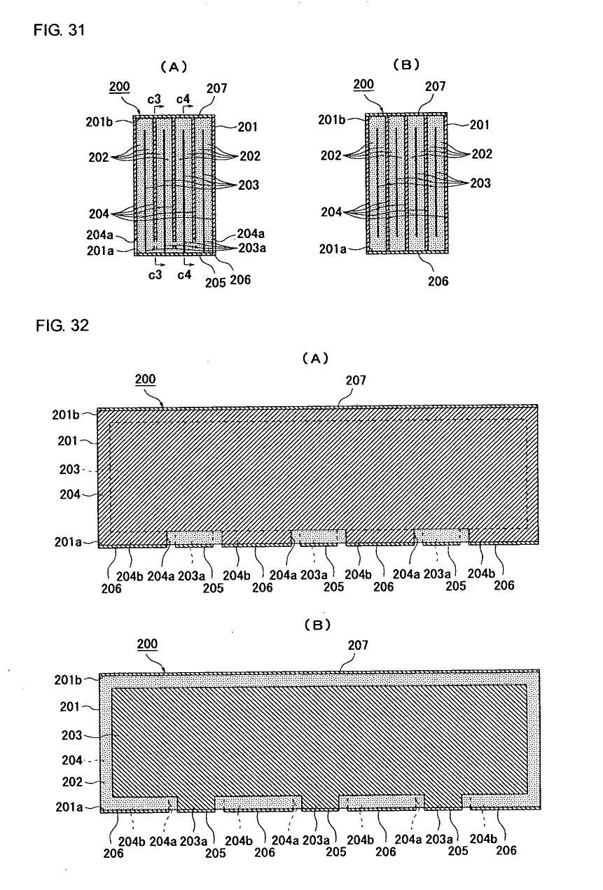

In this regard, FIG. 30A is a perspective view of a laminated varistor, viewed from the top surface side. FIG. 30B is a perspective view of the laminated varistor, viewed from the bottom surface side. FIG. 31A is a sectional view of a section taken along a line c1-c1 shown in FIG. 30A. FIG. 31B is a sectional view of a section taken along a line c2-c2 shown in FIG. 30A. FIG. 32A is a sectional view of a section taken along a line c3-c3 shown in FIG. 31A. FIG. 32B is a sectional view of a section taken along a line c4-c4 shown in FIG. 31A.

This laminated varistor 200 is provided with a rectangular parallelepiped laminated chip 201. This laminated chip 201 has a configuration in which a plurality of (four layers in the drawing) first conductor layers 203 and a plurality of (five layers in the drawing) second conductor layers 204 are disposed alternately and oppositely in a lateral direction with varistor layers 202 therebetween.

Each first conductor layer 203 is in the shape of a rectangle a size smaller than the second conductor layer 204, and includes three lead portions 203a having a predetermined width, at regular intervals. The end of each lead portion 203a is exposed at the bottom surface 201a of the laminated chip 201. The shape and the position of disposition of this lead portion 203a are not specifically limited as long as the lead portion 203a can be connected to a first electrode portion 205 described below. The top end of each first conductor layer 203 is located inside and at a distance from the top surface 201b of the laminated chip 201. Both side edges of each first conductor layer 203 are located inside and at a distance from two side surfaces in a direction orthogonal to the lamination direction of the conductor layers of the laminated chip 201.

Each second conductor layer 204 is in the shape of substantially the same rectangle as the side surface in the lamination direction of the conductor layers of the laminated chip 201. Each second conductor layer 204 has three cut-out portions 204a at regular intervals and total four lead portions 204b having a predetermined width and sandwiching the cut-out portions 204a, the cut-out portion having the depth substantially equal to the vertical length of the lead portion 203a and having a width larger than the width of the lead portion 203a. The end of each lead portion 204b is exposed at the bottom surface 201a of the laminated chip 201, while being in no contact with the end of the lead portion 203a. The shape and the position of disposition of this lead portion 204b are not specifically limited as long as the lead portion 204b can be connected to a second electrode portion 206 described below. The top end of each second conductor layer 204 is exposed at the top surface 201b of the laminated chip 201. Both side edges of each second conductor layer 204 are exposed at two side surfaces in a direction orthogonal to the lamination direction of the conductor layers of the laminated chip 201. Furthermore, the second conductor layer 204 is located at each of two side surfaces in the lamination direction of the conductor layers of the laminated chip 201.

Three first electrode portions 205 connected to the ends of the lead portions 203a of each first conductor layer 203 exposed at the bottom surface 201a of the laminated chip 201 are disposed on the bottom surface 201a of the laminated chip 201. The first electrode portion 205 is in the shape of a belt in the lamination direction of the conductor layers of the laminated chip 201 and has a width substantially equal to the exposure width of the lead portion 203a.

Four second electrode portions 206 connected to their respective ends of the lead portions 204a of each second conductor layer 204 exposed at the bottom surface 201a of the laminated chip 201 are disposed on the bottom surface 201a of the laminated chip 201. The second electrode portion 206 is in the shape of a belt in the lamination direction of the conductor layers of the laminated chip 201 and has a width substantially equal to the exposure width of the lead portion 204a, while being in no contact with the first electrode portion 205.

Furthermore, a heat conductor portion 207 connected to the top end of each second conductor layer 204 exposed at the top surface 201b of the laminated chip 201 is disposed on the top surface 201b while covering all over the top surface 201b. As is clear from a production method described below, this heat conductor portion 207 is made of a conductor coating.

In the above-described laminated varistor 200, the ends of the lead portions 203a of each first conductor layer 203 are connected to three first electrode portions 205 disposed on the bottom surface 201a of the laminated chip 201, and the ends of the lead portions 204a of each second conductor layer 204 are connected to four second electrode portions 206 disposed on the bottom surface 201a of the laminated chip 201. Since the top end of each second conductor layer 204 is connected to the heat conductor portion 207 disposed on the top surface 201b of the laminated chip 201, a predetermined capacitance can be attained between the first electrode portions 205 and the second electrode portions 206 disposed on the bottom surface 201a of the laminated chip 201.

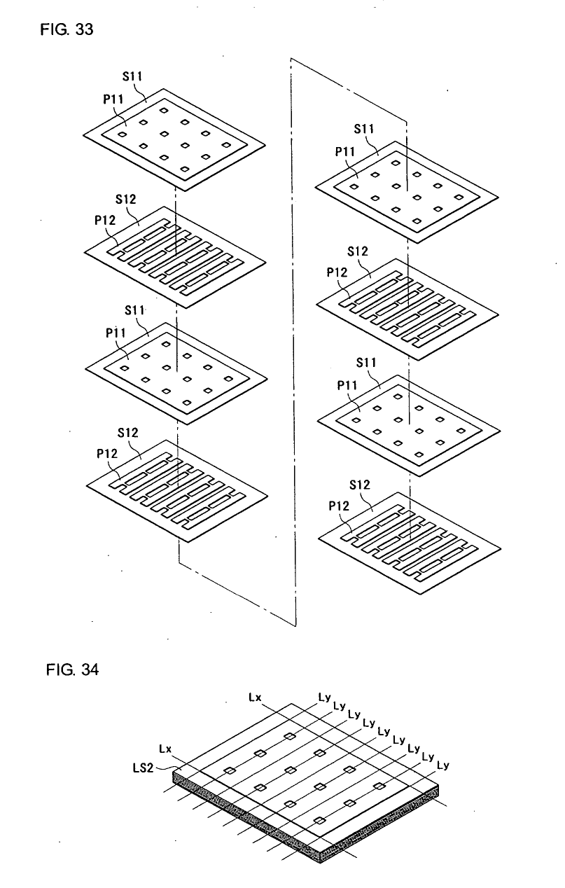

Here, an example of a method for producing the above-described laminated varistor 200 will be described with reference to FIG. 33 to FIG. 37.

In the production, sheets S11 and S12 shown in FIG. 33 are prepared. A green sheet is produced by applying and drying a predetermined thickness of ceramic slurry containing a semiconductor ceramic powder, e.g., zinc oxide, and a conductor paste containing a metal powder, e.g., silver or nickel, is printed on the green sheet through the use of a screen or the like, followed by drying, to produce a conductor pattern P11 for the second conductor layer 204, so that the sheet S11 is prepared. A green sheet is produced by applying and drying a predetermined thickness of ceramic slurry containing a semiconductor ceramic powder, e.g., zinc oxide, and a conductor paste containing a metal powder, e.g., silver or nickel, is printed on the green sheet through the use of a screen or the like, followed by drying, to produce a conductor pattern P12 for the first conductor layer 203, so that the sheet S12 is prepared.

In this regard, for convenience in illustration, 8 units are taken from the sheets S11 and S12 shown in the drawing. However, the number of units to be taken practically from the sheets S11 and S12 is larger than this.

The above-described sheets S11 and S12 are laminated in the order shown in FIG. 33, and are pressure-bonded, so that a laminated sheet LS2 shown in FIG. 34 is produced.

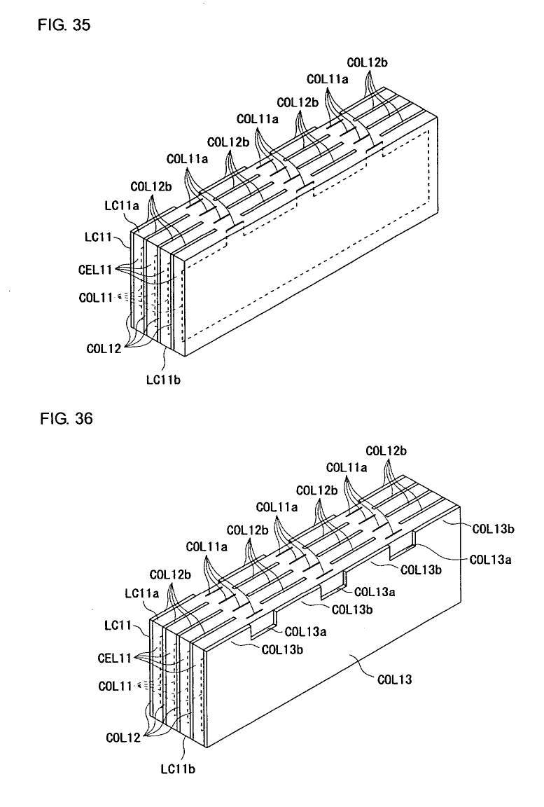

The laminated sheet LS2 is cut along the lines Lx and Ly shown in FIG. 34 and, thereby, laminated chips LC11 shown in FIG. 35 are produced.

This laminated chip LC11 has a configuration in which four unfired conductor layers COL11 for serving as the first conductor layers 203 and four unfired conductor layers COL12 for serving as the second conductor layers 204 are disposed alternately and oppositely in a lateral direction with unfired varistor layers CEL11 therebetween. The ends of lead portions COL11a of each unfired conductor layer COL11 are exposed at the bottom surface LC11a of the laminated chip LC11. The ends of lead portions COL12b of each unfired conductor layer COL12 are exposed at the bottom surface LC11a of the laminated chip LC11, and the top end of each unfired conductor layer COL12 is exposed at the top surface LC11b of the laminated chip LC11.

As shown in FIG. 36, a conductor paste similar to that in the above description is applied to one side surface (the side surface at which the unfired varistor layer is exposed) in the lamination direction of the conductor layers of the above-described laminated chip LC11 to take the same shape as the unfired conductor layer COL12, followed by drying, so that an unfired conductor layer COL13 for serving as remaining one second conductor layer 204 is formed. This unfired conductor layer COL13 is in the same shape as that of the unfired conductor layer COL12 but has three cut-out portions COL13a at regular intervals on the bottom end thereof and four lead portions COL13b at regular intervals to sandwich the cut-out portions COL13a.

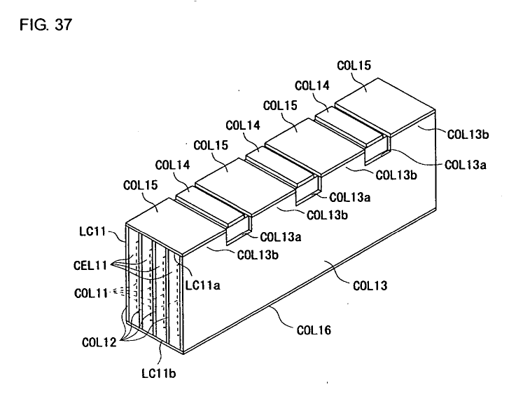

As shown in FIG. 37, a conductor paste similar to that in the above description is applied to the bottom surface of the above-described laminated chip LC11 to take the shape of a belt, followed by drying, so that three unfired electrode portions COL14 for serving as the first electrode portions 205 are formed. In addition, a conductor paste similar to that in the above description is applied to the bottom surface of the above-described laminated chip LC11 to take the shape of a belt, followed by drying, so that four unfired electrode portions COL15 for serving as the second electrode portions 206 are formed. Furthermore, a conductor paste similar to that in the above description is applied all over the top surface of the laminated chip LC11, followed by drying, so that an unfired conductor portion COL16 for serving as the heat conductor portion 207 is formed.

Subsequently, a plurality of laminated chips LC11 shown in FIG. 37 are fired by one operation. As described above, the laminated varistors 200 are produced.

In the above-described example of the production method, the unfired conductor layer COL13 for serving as the remaining one second conductor layer 204, the unfired electrode portions COL14 for serving as the first electrode portions 205, the unfired electrode portions COL15 for serving as the second electrode portions 206, and the unfired conductor portion COL16 for serving as the heat conductor portion 207 are formed on the laminated chip LC11 shown in FIG. 35, and these are fired simultaneously with the laminated chip LC11. However, only the laminated chip LC11 shown in FIG. 35 may be fired, the unfired conductor layer COL13, the unfired electrode portions COL14, the unfired electrode portions COL15, and the unfired conductor portion COL16 may be formed sequentially on the resulting laminated chip LC11, and a firing treatment may be performed.

In the above-described production method, the remaining one second conductor layer 204, the first electrode portions 205, the second electrode portions 206, and the heat conductor portion 207 are formed by a thick film forming method through application of the paste and firing. However, at least one of them may be formed by a thin film forming method, e.g., electrolytic plating or sputtering.

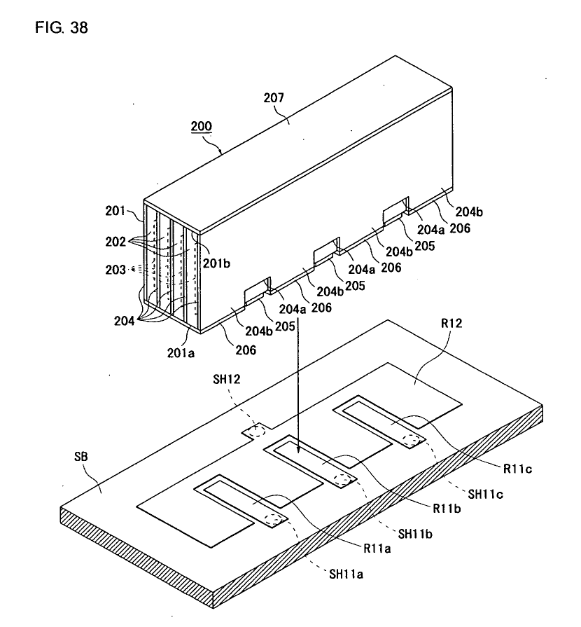

As shown in FIG. 38, the above-described laminated varistor 200 is mounted on a substrate SB having lands R11a to R11c and R12 corresponding to the first electrode portions 205 and the second electrode portions 206, respectively, in such a way that the bottom surface of the laminated chip 201 is faced toward a substrate mounting surface, three first electrode portions 205 are connected to the lands R11a to R11c, and four second electrode portions 206 are connected to the land R12.

In this regard, in the substrate SB shown in FIG. 38, the lands R11a to R11c serve as positive electrodes and the land R2 serves as a ground electrode, or the lands R11a to R11c serve as ground electrodes and the land R2 serves as a positive electrode. Wirings of the lands R11a to R11c are routed to a back of the substrate via through holes SH11a to SH11c, and a wiring of the other land R12 is routed to the back of the substrate via a through hole SH12.

In the above-described laminated varistor 200 and a structure (mounting structure) in which the laminated varistor 200 is mounted on the substrate SB, when the heat from an exothermic device, e.g., an IC, disposed in the vicinity is transferred to each of the first conductor layers 203 and the second conductor layers 204 via the substrate SB, lands R11a to R11c and R12, the first electrode portions 205, and the second electrode portions 206 or when heat generation occurs as a current passes through the varistor layers 202, the heat is directly and highly efficiently transferred from each second conductor layer 204 to the heat conductor portion 207, and is effectively released to the outside from the heat conductor portion 207.

Since the heat conductor portion 207 is disposed covering all over the top surface of the laminated chip 201, an area to release the heat to the outside can be adequately ensured, and the above-described heat radiation can be performed more effectively.

Furthermore, the second conductor layer 204 is exposed at each of two side surfaces in the lamination direction of the conductor layers of the laminated chip 201. In addition, both side edges of each second conductor layer 204 are exposed at two side surfaces in a direction orthogonal to the lamination direction of the conductor layers of the laminated chip 201. Consequently, these exposed portions are made to perform the function similar to that of the heat conductor portion and, thereby, the above-described heat radiation action can be facilitated.

The above-described laminated varistor 200 is provided with the heat conductor portion 207 made of the conductor coating. However, as described with reference to FIG. 11A, a conductor sheet (heatsink) made of a high-thermal-conductivity metal, e.g., aluminum, may be connected to the conductor coating 207 to constitute the heat conductor portion.

This conductor sheet may be a flat-shaped sheet. In addition, a conductor sheet having a concave portion to receive a part of the laminated chip 201, as described with reference to FIG. 11B, or the conductor sheet having a plurality of fins, as described with reference to FIG. 11C, may be used. Alternatively, as described with reference to FIG. 11D, the above-described conductor coating 207 can be eliminated from the configuration by disposing the conductor sheet connected to the top end of each second conductor layer 204.

In the case where at least two laminated varistors 200 are mounted side by side on the substrate, as described with reference to FIG. 12, a shared conductor sheet (heatsink) made of a high-thermal-conductivity metal, e.g., aluminum, may be connected to conductor coatings 207 of a plurality of laminated varistors 200. The shared conductor sheet has a shape in accordance with the arrangement form of at least two laminated varistors 200 mounted side by side on the substrate.

This shared conductor sheet may be a flat-shaped sheet. In addition, a shared conductor sheet having a plurality of concave portions to receive a part of each laminated chip 201, as described with reference to FIG. 13, or a conductor sheet having a plurality of fins, as described with reference to FIG. 14, may be used. Alternatively, as described with reference to FIG. 15, a laminated varistor having a configuration in which the above-described conductor coating 207 is eliminated may be used by disposing the conductor sheet connected to the top end of each second conductor layer 204 of the plurality of laminated varistors 200.

In the case where at least two laminated varistors 200 are mounted side by side on the substrate, the mounting on the substrate can be simply conducted by forming a varistor module, as described with reference to FIG. 16, in advance. The varistor module is constructed by disposing a plurality of laminated varistors 200 in a predetermined array in such a way that each conductor coating 207 is connected to one surface of a conductor sheet (heatsink) made of a high-thermal-conductivity metal, e.g., aluminum. The heat radiation action after the mounting is as described above.

This conductor sheet may be a flat-shaped sheet. In addition, a conductor sheet having a plurality of concave portions in a predetermined array to receive a part of each laminated chip 201, as described with reference to FIG. 17, or a conductor sheet having a plurality of fins on the opposite surface, as described with reference to FIG. 18, may be used. Alternatively, as described with reference to FIG. 19, a laminated varistor having a configuration in which the above-described conductor coating 207 is eliminated may be used by disposing the plurality of laminated varistors 200 in such a way that the top end of each second conductor layer 204 thereof is connected to one surface of the conductor sheet.

In the above-described laminated varistor 200, the top end of each second conductor layer 204 is exposed at the top surface 201b of the laminated chip 201 and is connected to the heat conductor portion 207. However, as shown in FIG. 39, the top end of each second conductor layer 204′ may be located inside and at a distance from the top surface 201b of the laminated chip 201. In addition, the top end of each first conductor layer 203′ may be exposed at the top surface 201b of the laminated chip 201, and this may be connected to the heat conductor portion 207. In this manner, the heat radiation function similar to that described above can also be attained.

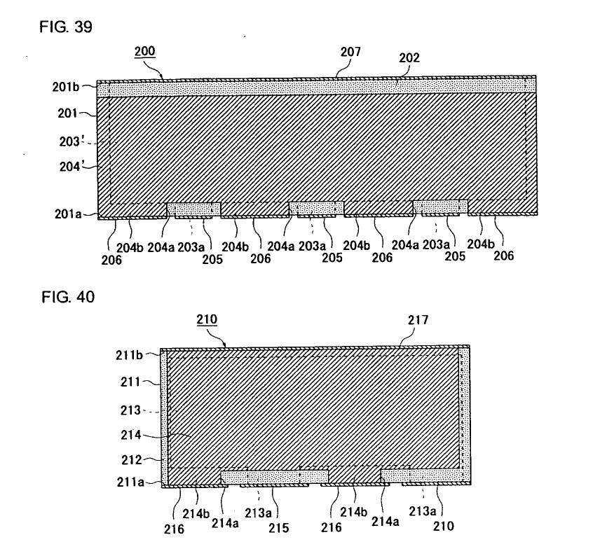

Furthermore, in the above-described laminated varistor 200, the number of first electrode portions 205 is different from the number of second electrode portions 206. However, the same number (two) of first electrode portions 215 and second electrode portions 216 may be included, as in a laminated varistor 210 shown in FIG. 40.

In addition, in the above-described laminated varistor 200, the structures of the laminated varistors described with reference to FIG. 22 to FIG. 29 according to the third embodiment to the tenth embodiment can be appropriately adopted, as in the laminated varistor 10 shown in FIG. 1 to FIG. 4.

What is claimed is:

1. A laminated varistor comprising:
a rectangular parallelepiped laminated chip comprising a plurality of first conductor layers and a plurality of second conductor layers disposed alternately with varistor layers therebetween;
at least one first electrode disposed on a first surface of the laminated chip and connected to the first conductor layers;
at least one second electrode disposed on the first surface of the laminated chip and connected to the second conductor layers, wherein the second electrode is spaced apart from the first electrode; and
a first heat conductor disposed on a second surface of the laminated chip and connected to the first conductor layers or the second conductor layers.

2. The laminated varistor according to claim 1, wherein the first heat conductor comprises a conductor coating.

3. The laminated varistor according to claim 1, wherein the first heat conductor comprises a conductor sheet.

4. The laminated varistor according to claim 1, wherein the first heat conductor comprises a conductor coating and a conductor sheet connected to the conductor coating.

5. The laminated varistor according to claim 3, wherein the conductor sheet comprises a concave portion configured to receive a part of the laminated chip.

6. The laminated varistor according to claim 3 or 5, wherein the conductor sheet comprises a plurality of fins.

7. The laminated varistor according to claim 1, wherein the second surface is opposite the first surface.

8. The laminated varistor according to claim 1, wherein the second surface is adjacent to the first surface.

9. The laminated varistor according to claim 1, wherein the first heat conductor is additionally disposed on a third surface of the laminated chip, wherein the second surface is opposite the first surface and the third surface is adjacent to the first surface.

10. The laminated varistor according to claim 1, wherein the first heat conductor covers substantially the entire second surface.

11. The laminated varistor according to claim 1, manufactured by a process comprising disposing the first heat conductor on the laminated chip prior to connecting the first heat conductor to the first conductor layers or the second conductor layers.

12. The laminated varistor according to claims 1, further comprising a second heat conductor connected to the first conductor layers or the second conductor layers and disconnected from the first heat conductor.

13. The laminated varistor according to claims 1, wherein at least one of the first electrode and the second electrode comprise a wraparound portion extending to at least one surface adjacent to the first surface.

14. A mounting structure of a laminated varistor, comprising at least one laminated varistor is mounted on a substrate in such a way that a first electrode of the laminated varistor is connected to a first land on a mounting surface and a second electrode portion is connected to a second land on the mounting surface, wherein the laminated varistor comprises a rectangular parallelepiped laminated chip comprising a plurality of first conductor layers and a plurality of second conductor layers disposed alternately with varistor layers therebetween, at least one first electrode disposed on a first surface of the laminated chip and connected to the first conductor layers, at least one second electrode disposed on the first surface of the laminated chip and connected to the second conductor layers, wherein the second electrode is spaced apart from the first electrode, and a first heat conductor disposed on a second surface of the laminated chip and connected to the first conductor layers or the second conductor layers.

15. The mounting structure according to claim 14, wherein the first heat conductor portion comprises a conductor coating.

16. The mounting structure according to claim 14, wherein the first heat conductor portion comprises a conductor sheet.

17. The mounting structure according to claim 14, wherein the first heat conductor comprises a conductor coating and a conductor sheet connected to the conductor coating.

18. The mounting structure according to claim 16 or 17, wherein the conductor sheet comprises a concave portion configured to receive a part of the laminated chip.

19. The mounting structure according to claim 16 or 17, wherein the conductor sheet comprises a plurality of fins.

20. The mounting structure according to claim 16 or 17, wherein a plurality of laminated varistors are mounted side by side on the substrate, and each laminated varistor is connected to a single common conductor sheet.

21. A varistor module comprising:
a conductor sheet of a predetermined shape; and
a plurality of laminated varistors, each comprising a rectangular parallelepiped laminated chip comprising a plurality of first conductor layers and a plurality of second conductor layers disposed alternately with varistor layers therebetween, at least one first electrode disposed on a first surface of the laminated chip and connected to the first conductor layers, and at least one second electrode disposed on the first surface of the laminated chip and connected to the second conductor layers, wherein the second electrode is spaced apart from the first electrode, the laminated varistors being disposed in a predetermined array on the conductor sheet such that a second surface of the laminated chip of each laminated varistor faces the conductor sheet and the conductor sheet connects to the first conductor layer or the second conductor layer of each laminated varistor.

22. The varistor module according to claim 21, wherein the conductor sheet comprises concave portions, each configured to receive a part of the laminated chip of one of the plurality of laminated varistors.

23. The varistor module according to claim 21 or 22, wherein the conductor sheet comprises a plurality of fins.
